(19) United States
(12) Patent Application Publication
(10) Pub. No.: US 2024/0295875 A1
(43) Pub. Date: Sep. 5, 2024

(54) A METHOD OF MONITORING THE CONDITION OF A MOVABLE MEMBER IN A LINEAR MOTOR SYSTEM, CORRESPONDING LINEAR MOTOR SYSTEM, FORMING ASSEMBLY AND COMPUTER PROGRAM PRODUCT

(71) Applicant: TETRA LAVAL HOLDINGS & FINANCE S.A., PULLY (CH)

(72) Inventor: Daniele CALTABIANO, Woodside, CA (US)

(73) Assignee: TETRA LAVAL HOLDINGS & FINANCE S.A., Pully (CH)

(21) Appl. No.: 18/574,803

(22) PCT Filed: Jul. 13, 2022
(86) PCT No.: PCT/EP2022/069592

§ 371 Date: Dec. 28, 2023

(30) Foreign Application Priority Data
Aug. 5, 2021 (EP) 21189791.3

(51) Int. Cl. G05B 23/02

(52) U.S. Cl. CPC G05B 23/0256

(57) ABSTRACT

There is described a method of monitoring a condition of a movable member in a linear motor system, the method comprising: providing a linear motor system comprising a track and at least one movable member coupled to the track and configured to move along the track, the movable member comprising a vibration sensor thereon, positioning the movable member at a monitoring region of the track, applying vibration to the movable member, and detecting a response of the movable member to the vibration by way of the vibration sensor.

### TECHNICAL FIELD

The present invention relates to linear motor systems comprising one or more tracks and movable members coupled thereto and a method for monitoring the condition of such movable members. The linear motor system according to the instant invention may be used in industrial applications, e.g. in a forming assembly for forming a plurality of objects such as a packaging assembly configured to form and seal a plurality of packs containing pourable products, in particular pourable food products.

### BACKGROUND ART

Linear motor systems are known and used in industrial applications to improve efficiency and flexibility. Such linear motor systems comprise a plurality of movable members movable, independently from each other, on one or more tracks. For example, the linear motor system comprises independent carts movable along a racetrack.

For example, it is known use of forming assemblies such as packaging assemblies comprising a plurality of movable members movable independently from each other on tracks and configured to form and/or seal objects such as packages made of sterilized packaging material configured to receive pourable food products, such as fruit juice, UHT (ultra-high temperature-treated) milk, wine, tomato sauce, etc.

These packages are normally produced in fully automatic packaging assemblies, in which a continuous tube is formed from a web of packaging material fed to such packaging assembly. To obtain the final package, the web is folded and sealed longitudinally to form the tube, which is fed along a vertical advancing direction. The tube is then filled with the sterilized food product from above and is sealed and subsequently cut along equally spaced transversal cross sections.

Although being functionally valid, the known linear motor systems are still open to further improvement. For example, a need is felt for monitoring the condition of the movable members in the linear system, e.g. the condition of a coupling of the movable member to the track and/or a condition of the elements that are relatively movable with respect to the movable member.

By condition, the instant description intends the state of a movable member or an element thereof with regard to its appearance, quality, or working order.

This way, the correct operation of the movable member along its entire life is facilitated. In fact, like every mechanical system, all the components are affected by mechanical plays that, during the time, can decrease the overall stiffness and therefore the repeatability of the whole system. Accordingly, in a forming assembly, a need is felt to detect premature degradation of performance, e.g. for allowing a machine operator to take corrective actions before a forming error or an issue on sterility occurs.

### SUMMARY OF THE INVENTION

It is therefore an object of the present invention to provide a method of monitoring a condition, e.g. the state and/or quality and/or working order, of a movable member in a linear motor system which can facilitate achieving one or more of the above-mentioned needs in a straightforward and low-cost manner. Such an object is achieved by means of a method and a corresponding linear motor system having the features set forth in the claims that follow.

Such an object may be achieved by means of a forming assembly for forming one or more objects, e.g. a packaging assembly for forming and sealing a plurality of packs, the forming assembly comprising a linear motor system according to one or more embodiments.

Such an object may be achieved by means of a computer program product loadable in the memory of at least one electronic control unit, e.g. a system control and/or processing unit and/or a processing unit of a movable member, and comprising software code portions for performing the steps of the method according to one or more embodiments.

The disclosed embodiments may achieve one or more advantages, e.g.:
the condition of the movable members and/or relatively movable parts thereof can be monitored during the life of the linear motor system,
such monitoring may facilitate reducing handling of defective products, and/or
faults or damages in the mechanical moving parts, e.g. due to play gained over time or stuck components, can be detected in an early phase.

Play in mechanical systems may affect the forming performances lowering the repeatability and the accuracy of the overall forming process. If not monitored, such play may lead to forming defects.

### BRIEF DESCRIPTION OF THE DRAWINGS

Embodiments of the present invention will be described by way of example with reference to the accompanying drawings, in which:

FIG. 1 is a schematic illustration of a linear motor system according to one or more embodiments,

FIG. 2 is a non-limiting example of a possible vibration applied on the movable member of a linear motor system,

FIG. 3 is a schematic illustration of a measured response in frequency of the movable member, and

FIG. 4 exemplifies a schematic front view, with parts removed for clarity, of a packaging assembly for forming a plurality of sealed packs according to the present invention.

### DESCRIPTION OF THE INVENTION

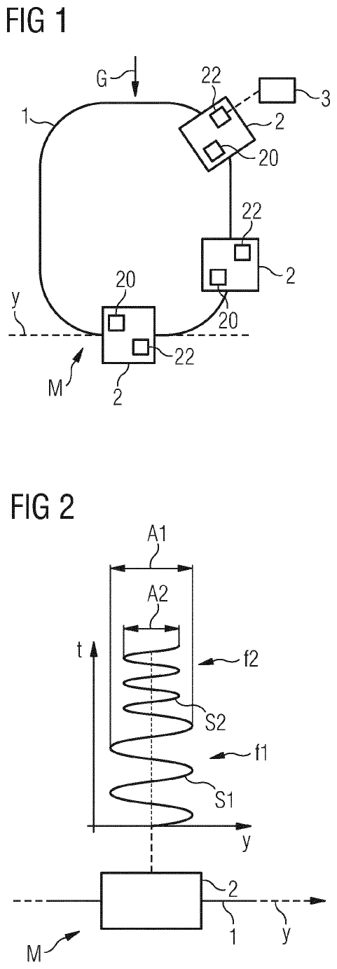

FIG. 1 illustrates an example of a linear motor system according to one or more embodiments. Permanent magnets arrangements and coils—i.e. movable members and a respective track—define such type of linear motors, which, in a known manner, are configured to independently control the movement of the movable members along the respective track. The track may comprise a single rail or a plurality of rails. The rails can be closed in a racetrack configuration, as exemplified in FIG. 1, or they may be open.

The linear motor system comprises one or more tracks 1, e.g. a single track for simplicity in FIG. 1, and one or more movable members 2, preferably movers or carts, coupled to the track 1 and configured to move along the respective track 1. In FIG. 1, the movable members 2 race along the track 1 in a first direction X exemplified by the arrow. For example, the track 1 defines an endless path on which the movable members 2 are configured to move cyclically.

The linear motor system further comprises a system control and processing unit 3 configured to position the movable member 2 at a monitoring region M of the track 1 and apply vibration to the movable member 2. The system control and processing unit 3 may be positioned at the track 1. The movable members 2 in the system may comprise respective processing units 20 that may be coupled, e.g. wirelessly, to the system control and processing unit 3.

For example, the processing unit 20 in the movable member 2 may be configured to transmit data to the system control and/or processing unit 3 at each cycle, when the respective movable member 2 passes thereat. The transmission of data between the movable members 2 and the system control and/or processing unit 3 may occur by means of (e.g. low-energy) wireless transmission modules, e.g. Bluetooth low-energy transmission modules.

For example, the monitoring region M may comprise a linear region, e.g. a plateau, of the track 1 extending in a second direction Y perpendicular to a gravity acceleration direction G.

For example, the monitoring region may be a region where the movable member 2 would lie if no force was applied on the movable member 2 by the linear motor system, e.g. by means of the magnetic coils. In other words, as exemplified in FIG. 1, the monitoring region M may be the region at the bottom of the track 1. In addition or in alternative, the monitoring region M may be at the top of the track 1.

The movable members 2 may further comprise one or more vibration sensors 22 configured to detect a response of the respective movable members 2 to the vibration applied thereon. The vibration sensors 22 may be positioned on the movable members 2.

The processing unit 3 and/or 20 may be configured to identify, e.g. at an early stage, faults or errors as a function of the response to the vibration measured by the one or more vibration sensors 22.

If a fault or error is identified, the processing unit 3, 20 may be configured to:
generate an alert, e.g. indicative of the detected error, and/or
prevent operation of the movable members 2.

The linear motor system may comprise a user interface configured to show the alarm signal.

In one or more embodiments, the vibration sensors 22 may comprise at least one inertial sensor, preferably comprising one or more motion sensor, e.g. (3D) accelerometers, and/or one or more rotation sensors, such as (3D) gyroscopes. A measure of the inertial sensors may be indicative of an acceleration of the movable member 2. The vibration may be detected based on such measure.

In addition or in alternative, the vibration sensors 22 may comprise a position error sensor and/or a torque sensor.

For example, the vibration sensor 22 may be potted with epoxy resin and fixed to the movable member 2. Advantageously, this way the inertial sensors may become virtually water and shock proof.

One or more embodiments may thus relate to a method of monitoring a condition, e.g. the state and/or quality and/or working order, of a movable member in a linear motor system as described previously. The method comprises:
positioning the movable member at the monitoring region M of the track 1, e.g. a plateau at the bottom of the track 1 as exemplified in FIG. 1,
applying vibration, e.g. one or more vibrations at different frequencies, to the movable member 2, and
detecting a response of the movable member 2 to the vibration by means of the vibration sensor 22.

As exemplified in FIG. 2, the step of applying vibration to the movable member 2 may comprise applying one or more predetermined (e.g. sinusoidal) motion profiles S1, S2 to the movable member 2. The motion profiles may comprise for example sinusoids S1, S2 having predetermined frequencies f1, f2 and/or amplitudes A1, A2, that may vary over time.

For the sake of ease of understanding, the motion profile exemplified in the figures is a sinusoidal motion profile, however it may be possible to apply different, more complex motion profiles with a higher frequency content.

FIG. 2 exemplifies a motion profile of a movable member 2 along time t being subjected to a periodic oscillation having first frequency f1 and afterwards second frequency f2, different from the first frequency. In addition or in alternative, the motion profile may comprise sinusoids having a first amplitude A1 and a second amplitude A2, respectively, with the second amplitude being different from the first amplitude A1.

In one or more embodiments, the method may comprise applying a plurality of vibrations to the movable member 2, the vibrations having different frequencies, preferably between 0.5 Hz and 200 Hz. The method may thus comprise applying a (e.g. sinusoid) motion profile to the movable member 2, wherein the motion profile may comprise one or more frequencies f1, f2, preferably comprised between 0.5 Hz and 200 Hz. This way, a frequency sweep may be performed with a plurality of different frequencies. In other words, a plurality of vibrations having each a different frequency may be applied to the movable member 2.

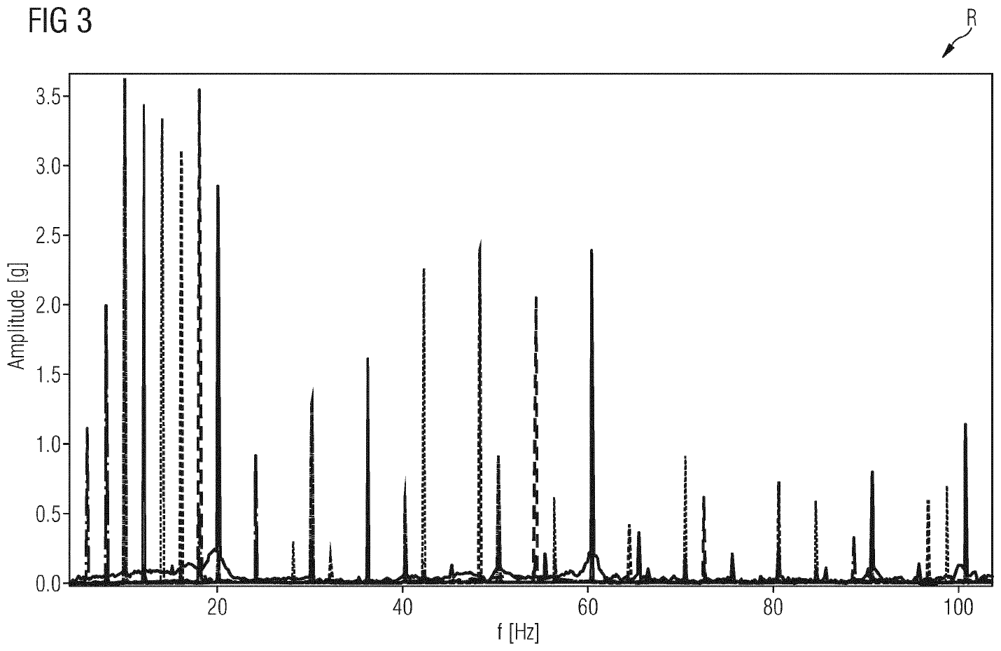

FIG. 3 exemplifies a measure of the response R to the vibration applied to the movable member 2. In particular, the measure comprises an amplitude A of a resonance of the movable member 2 with respect to a frequency f. That is, one or more vibrations at different frequencies may be applied to the movable member 2 and a response R thereof over the frequency domain f may be measured and plotted.

The method may comprise:
comparing the response R detected, e.g. the response R plotted in FIG. 3, to a predetermined vibration pattern, and
checking whether the response R differs from the predetermined vibration pattern, and
if the response R substantially corresponds to the predetermined vibration pattern, resuming operation of the movable member 2.

The predetermined vibration patter may comprise a predetermined healthy state frequency pattern or a mathematical/theoretical model.

At installation, the vibration may be applied to each movable member 2 to determine the predetermined vibration pattern. In other words, the method may comprise calibrating the movable member 2 at installation by applying one or more vibrations, e.g. a frequency to generate the sweep, to the movable member 2 pattern. In addition or in predetermined vibration alternative, the predetermined vibration pattern may be based on a standard response of movable members 2 of a specific type to vibration.

The step of checking whether the response R differs from the predetermined vibration pattern may comprise checking whether new resonances are plotted, e.g. a new amplitude A is plotted at a frequency f that is not present at said frequency f in the predetermined vibration pattern. In addition or in alternative, the step of checking whether the response R differs from the predetermined vibration pattern may comprise checking whether the resonances plotted differ of more than a predetermined amount with respect to the predetermined vibration pattern, e.g. one or more amplitudes A change of more than a predetermined amount at certain frequencies f with respect to amplitudes A at said certain frequencies f in the predetermined vibration pattern.

Accordingly, the response R substantially corresponds to the predetermined vibration pattern if the amplitude A changes non-negligibly. In other words, the response R substantially corresponds to the predetermined vibration pattern if the amplitude A changes within a predetermined amount with respect to the predetermined vibration pattern. This way, it is possible to monitor the condition of the movable member 2 also considering the noise that may occur due to the measurement of the vibration.

If the response R substantially corresponds, the method may comprise resuming operation of the movable member 2. If a plurality of movable members 2 are present, the measuring of the condition may be applied on all movable members 2 before resuming normal operation.

If one or more movable members 2 show that the response R does not substantially correspond to the predetermined vibration pattern, the method may comprise transmitting an alert to a user interface and/or preventing resumption or further operation of the movable members 2.

In one or more embodiments, the method may be applied periodically. That is, the method may comprise periodically interrupting operation of the linear motor system to monitor the condition of the movable members 2. For example, normal operation of the linear motor system may be interrupted every 500 hours to monitor the condition of the movable members 2.

Advantageously, the method according to one or more embodiments allows a precise monitoring of the condition of the movable members 2 and parts thereof. For example, during operation, one or more elements of the movable members 2 may be configured to move relatively with respect to a body of the movable member 2. Such movement, over time, may create play and/or degradation of the movable elements. Such play and/or degradation may be detected by means of studying the frequency response of the movable members 2 to vibration. In fact, the play and/or degradation may generate new/different movements when the movable members 2 are solicitated.

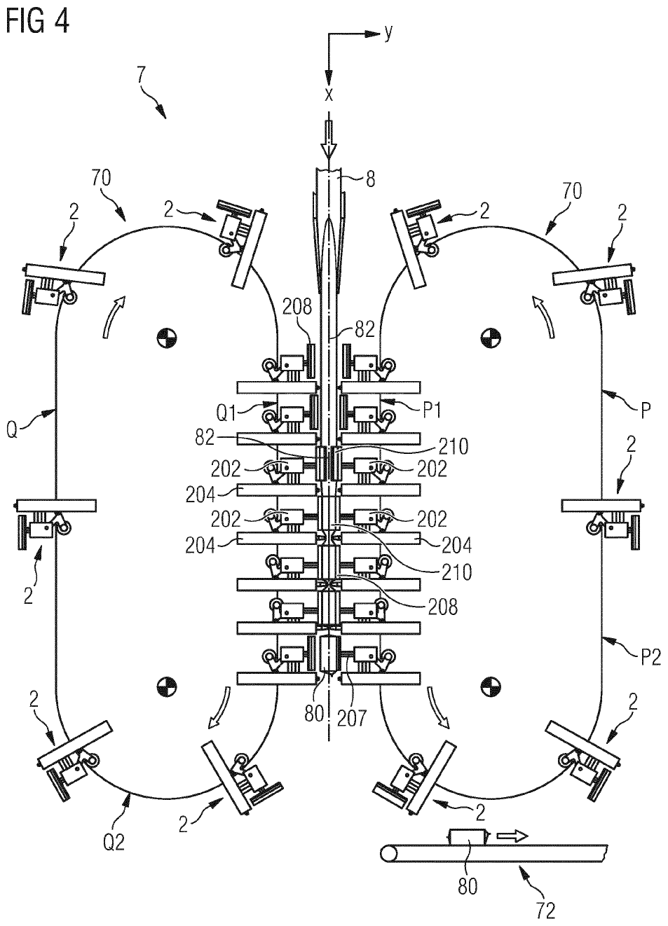

One or more embodiments, as illustrated in FIG. 4, refer to a forming assembly 7 configured to form one or more objects 80. In the following, a non-limiting example of a packaging assembly 7 is depicted, configured to form and seal a plurality of packs 80 containing a pourable product, preferably a pourable food product, starting from a tube 8 of packaging material. Whereas hereinafter reference is made to a packaging assembly 7, it will be appreciated that such is merely a non-limiting example for the ease of understanding and conciseness. Different types of forming assemblies 7 can exist that are not packaging assemblies. All features described in the following, even though related to a packaging assembly 7, can apply more in general to the forming assembly 7.

A tube 8 is formed in known manner by longitudinally folding and sealing a web (not shown) of packaging material. Tube 8 is then filled from above by a pipe (not shown) with the pourable product and is fed through packaging assembly 7 along a straight advancing direction X. In detail, tube 8 extends along a straight longitudinal, e.g. vertical, axis parallel to direction X.

The forming assembly 7, e.g. the packaging assembly 7, comprises a linear motor system according to one or more embodiments as described previously. Packaging assembly 1 comprises:
a pair of conveyors 70 arranged on respective lateral sides of tube 8, spaced apart with respect to one another, and configured to cooperate with tube 8; and
an outlet conveyor 72, which is arranged below conveyors 70 staggered with respect to axis X.

Each conveyor 70 substantially comprises the endless track 1 and a plurality of movable members 2, preferably movable members, coupled to, and cyclically movable along, one respective track 1. Each movable member 2 is configured to cyclically slide along track 1 of the respective conveyor 70. A plurality of movable members 2 slides, in use, along each track 1.

The forming assembly, e.g. the packaging assembly 7, thus comprises:
a pair of endless tracks 1 between which the tube 8 is fed along the (e.g. straight) advancement direction X;
a pair of movable members 2, each one of which movably coupled to, and cyclically movable along, one respective track 1,
a processing unit 3 configured to position the movable member at a monitoring region M of the track 1 and apply vibration to the movable member 2.

The movable member 2 comprises a vibration sensor 22 configured to detect a response of the movable member 2 to the vibration applied thereon.

As illustrated in FIG. 4, the two tracks 1 define respective endless paths P, Q arranged on opposite sides of the tube 8. More specifically, paths P, Q comprise:
respective operative branches P1, Q1, preferably rectilinear, between which tube 8 is fed and along which movable members 2 cooperate with tube 8; and
respective return branches P2, Q2, along which movable members 2 are detached from tube 8.

According to this preferred embodiment shown, paths P, Q are substantially oval-shaped.

In use, when sliding along the respective operative branch P1, Q1, each movable member 2 cooperates with a corresponding movable member 2—i.e. movable members 2 mutually cooperates two by two—defining in this way a pair of movable members 2 facing each other and cooperating with one another and with tube 8 while sliding along operative branches P1, Q1.

Each pair of movable members 2 is configured to cooperate with tube 8 to cyclically form and seal one respective pack 80 at a time, and cut the pack 80 to separate the pack 80 from tube 8, as shown in FIG. 4.

To this end, each movable member 2 comprises, at one of its sides, a forming unit 202 and a sealing unit 204 both configured to cooperate with tube 8 along the respective operative branches P1, Q1.

The forming units 202 are configured to respectively cooperate with tube portions 82 of tube 8 to form at least corresponding pack portions, more in particular corresponding packs 80. For this purpose, each forming unit 202 is carried by, preferably mounted on, the respective movable member 2 in a movable manner. The forming unit 202 may preferably comprise a half-shell, presenting a C-shaped cross section and comprising a back wall 208 and a pair of lateral flaps 210. In the embodiment shown, flaps 210 are movably coupled to wall 208. The flaps 210 project from opposite lateral edges of wall 208 when movable members move along operative branches P1, Q1, and are hinged to such edges.

In use, the half-shell of each forming unit 202 is configured to sequentially and cyclically cooperate in contact with tube portions 82 so as to form at least pack portions of respective packs 80.

Each half-shell is linearly movable transversally, e.g. orthogonally, to direction X, i.e. along direction Y, towards tube 8, i.e. towards the tube portion 82 that half-shell has to form. Each forming unit 202 comprises a movable element 207 linearly movable along direction Y, which carries a respective half shell.

Sealing units 204 are configured to cooperate with tube 8 to seal tube portions 82 at predetermined, equally spaced, successive cross sections crosswise to direction X. Furthermore, sealing units 204 are configured to cooperate with tube 8 to cut packs 80 at the cross sections, to separate packs 80 from one another.

On one side, each sealing unit 204 is mounted downstream of the corresponding forming unit 202 of the respective movable member 2 along the respective path P, Q and comprises a counter-sealing an device and extractable cutting element, for example a knife (not illustrated). On the other side, each sealing unit 204 is mounted downstream of the corresponding forming unit 202 of the respective movable member 2 along the respective path P, Q and comprises a sealing device and a seat, adapted to receive the knife of the corresponding sealing device configured to cooperate with such counter-sealing device. Sealing devices may comprise ultrasonic, induction or inductive heating sealing devices.

As shown in FIG. 4, when forming units 202 and sealing units 204 are advanced by the respective movable members 2 along the respective operative branch P1, Q1, the respective half-shells, sealing devices and counter-sealing devices move back and forth along a direction Y between:
a closed position, or operative position, in which half-shells, sealing devices and counter-sealing devices cooperate with respective tube portions 82 to form, seal and cut respective packs 80; and
an open position, or idle position, in which half-shells, sealing devices and counter-sealing devices are detached from tube 8 or from the formed packs 80.

When half-shells are in the operative (closed) position, flaps 210 of each half-shell rotate about the respective hinges, e.g. about an axis parallel to direction X, from a position in which they diverge from the respective wall 208, to a position in which they are substantially orthogonal to the wall 208, face flaps 210 of the other half-shell carried by the corresponding movable member 2 of the same pair and contact tube 8 to completely surround the respective tube portion 82 destined to form the respective pack 80.

When two half-shells of two respective forming units 202 of a pair of cooperating movable members 2 are both in the operative (closed) position, they define a substantially prismatic cavity and accordingly control the volume and shape of one respective pack 80 being formed.

When the counter-sealing device and sealing device of a pair of cooperating movable members 2 are in the operative (closed): position, they cooperate with one another to heat-seal tube 8, so as to form a top sealing band and a bottom sealing band. Then, the respective cutting element is extracted, so as to cut packs 80 between the top and bottom sealing band of two adjacent packs 80 and separate formed packs 80 from one another.

As exemplified in FIG. 4, a further movement occurs along direction X, between the sealing unit 204 and the forming unit 202, to form a top and/or bottom of the packs 80.

1. A method of monitoring a condition of a movable member in a linear motor system comprising a track and at least one movable member coupled to the track and configured to move along said track, the movable member comprising a vibration sensor thereon, the method comprising:
positioning the movable member at a monitoring region of the track,
applying vibration to the movable member, and
detecting a response of the movable member to the vibration by means of the vibration sensor.

2. The method of claim 1, comprising:
comparing the response detected to a predetermined vibration pattern, and
checking whether the response differs from the predetermined vibration pattern, and
if the response substantially corresponds to the predetermined vibration pattern, resuming operation of the movable member.

3. The method of claim 2, comprising, if the response fails to substantially correspond to the predetermined vibration pattern, transmitting an alert to a user interface and/or preventing resumption operation of the movable member.

4. The method of claim 1, wherein the applying of the vibration to the movable member comprises applying a predetermined motion profile to the movable member.

5. The method of claim 1, wherein the monitoring region comprises a linear region of the track extending in a direction perpendicular to a gravity acceleration direction.

6. The method of claim 1, comprising applying a plurality of vibrations to the movable member, the vibrations having different frequencies.

7. The method according to claim 1, comprising periodically interrupting operation of the linear motor system to monitor the condition of the movable member.

8. The method of claim 1, comprising calibrating the movable member at installation by applying at least a vibration to the movable member to generate the predetermined vibration pattern.

9. A computer program product loadable in the memory of at least one electronic control unit and comprising software code portions for performing the steps of the method of claim 1.

10. A linear motor system, comprising:
a track,
at least one movable member coupled to the track and configured to move along said track,
a processing unit configured to position the movable member at a monitoring region of the track and apply vibration to the movable member,
wherein the movable member comprises a vibration sensor configured to detect a response of the movable member to the vibration applied thereon.

11. The linear motor system of claim 10, wherein the monitoring region comprises a region where the movable member would lie if no force was applied on the movable member by the linear motor system.

12. The linear motor system of claim 10, wherein the vibration sensor comprises at least one inertial sensor and/or a position error sensor and/or a torque sensor.

13. The linear motor system of claim 10, wherein the vibration sensor is potted with epoxy resin and fixed to the movable member.

14. A forming assembly configured to form a plurality of packages and comprising a linear motor system according to claim 10, the forming assembly comprising:
a pair of endless tracks,
a pair of movable members, each one of which movably coupled to, and cyclically movable along, one respective track,
a processing unit configured to position the movable member at a monitoring region of the track and apply vibration to the movable member,
wherein the movable member comprises a vibration sensor configured to detect a response of the movable member to the vibration applied thereon.

15. The forming assembly of claim 14, comprising a packaging assembly configured to form and seal a plurality of packs containing a pourable product starting from a tube of packaging material, the packaging assembly comprising a pair of endless tracks between which said tube is fed along a straight advancement direction, and
wherein each movable member of said pair of movable members comprises a respective forming unit and a respective sealing unit linearly movable towards said tube, transversally to said advancement direction, to cyclically cooperate in contact with successive tube portions, so as to form and seal at least corresponding pack portions of respective packs, respectively.

16. The method of claim 1, comprising applying a plurality of vibrations to the movable member, the vibrations having different frequencies between 0.5 Hz and 200 Hz.

17. The method of claim 1, wherein the applying of the vibration to the movable member comprises applying a sinusoidal motion profile to the movable member.

18. The linear motor system of claim 10, wherein the vibration sensor comprises: i) at least one motion sensor and at least one rotation sensor; and/or ii) a position error sensor; and/or iii) a torque sensor.
